(19) United States
(12) Patent Application Publication
(10) Pub. No.: US 2022/0407329 A1
(43) Pub. Date: Dec. 22, 2022

(54) BATTERY CHARGE REGULATION

(71) Applicant: HEWLETT-PACKARD DEVELOPMENT COMPANY, L.P., Spring, TX (US)

(72) Inventors: Shih-Hsiung Tu, Taipei (TW); Chiang-Hsien Tai, Taipei (TW); Isaac Lagnado, Spring, TX (US)

(73) Assignee: HEWLETT-PACKARD DEVELOPMENT COMPANY, L.P., Spring, TX (US)

(21) Appl. No.: 17/349,145

(22) Filed: Jun. 16, 2021

(51) Int. Cl. H02J 7/00

(52) U.S. Cl. CPC H02J 7/0071; H02J 7/00712; H02J 7/0048

(57) ABSTRACT

In one example in accordance with the present disclosure, an electronic device is described. An example electronic device includes a pattern identifier to identify a pattern of activity and inactivity of the electronic device. An example computing also includes a scheduler to determine (1) a first interval wherein the electronic device is predicted to be inactive and charging of a battery of the electronic device is to be capped at a first level and (2) a second interval wherein the electronic device is predicted to be active and charging of the battery is to be capped at a second level. The example electronic device also includes a battery controller to regulate battery charging based on a schedule of the first interval and the second interval.

### BACKGROUND

Electronic devices are used by millions of people daily to carry out business, personal, and social operations. Examples of electronic devices include desktop computers, laptop computers, all-in-one devices, tablets, smartphones, and wearable smart devices to name a few. While particular reference is made to a few types of electronic devices, there are innumerable types of electronic devices to which the current specification may apply.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an electronic device to regulate battery charging, according to an example.

FIGS. 2A and 2B depict a pattern of activity and a schedule for regulating battery charging, according to an example.

FIG. 3 is a block diagram of an electronic device to regulate battery charging, according to an example.

FIG. 4 depicts a pattern of activity for regulating battery charging, according to an example.

FIG. 5 depicts a schedule during battery charge regulation, according to an example.

FIG. 6 depicts a schedule during battery charge regulation, according to an example.

FIG. 7 is a flowchart of a method for regulating battery charge, according to an example.

FIG. 8 depicts a schedule during battery charge regulation, according to an example.

FIG. 9 depicts a schedule during battery charge regulation, according to an example.

FIG. 10 depicts a non-transitory machine-readable storage medium for regulating battery charge, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Electronic devices are found everywhere in modern society and are used by tens and hundreds of millions of users every day. Examples of electronic devices include desktop computers, laptop computers, all-in-one devices, tablets, smartphones, and wearable smart devices. While particular reference is made to a few types of electronic devices, there are innumerable types of electronic devices to which the current specification may apply. Many of these electronic devices are portable and can be carried about with a user from place to place. As such, electronic devices include batteries that provide portable power to execute the operations of the electronic device when disconnected from an outlet. Over time and with use, the portable power source, i.e., the battery, drains and may be plugged into an external power source, such as into an electrical outlet to be re-charged. The capacity of the battery refers to the amount of power it can supply to execute operations and provide functionality. That is, a battery at 100% capacity can provide power for more applications or for a longer period of time than when the battery is at 80% capacity. Accordingly, a user may desire to have an electronic device, such as a phone or laptop computer, with 100% battery capacity when the user unplugs the electronic device from an external power source.

However, maintaining a battery at full capacity may have deleterious effects on the battery. Specifically, a battery held in a high state of charge may have a greater rate of deterioration and may trigger a reduction in the usable hours of a battery in between recharges. However, maintaining a battery at less than a full charge reduces the number of operations or time that the battery can power the components of the electronic device.

Accordingly, the present specification describes an electronic device that addresses these and other concerns. For example, the electronic device may collect user data to identify patterns of user behavior. Based on the patterns of behavior, the electronic device dynamically switches battery charging/discharging profiles such that (1) a full capacity of the battery is provided when it is predicted that a user will be actively using the electronic device and (2) the battery is maintained at a less-than-full capacity when it is predicted that a user will not be actively using the electronic device for an extended period of time. Such an electronic device therefore balances providing a user with full battery capacity when desired by a user and increasing useable battery life by maintaining the battery in a less-than-full capacity when it is not expected to be used by the user.

Specifically, the present specification describes an electronic device. The electronic device includes a pattern identifier to identify a pattern of activity and inactivity of the electronic device. The electronic device also includes a scheduler to determine (1) a first interval wherein the electronic device is predicted to be inactive and charging of a battery of the electronic device is to be capped at a first level and (2) a second interval wherein the electronic device is predicted to be active and charging of the battery is to be capped at a second level. The electronic device also includes a battery controller to regulate battery charging based on a predicted schedule of the first interval and the second interval.

In another example, the electronic device includes a data collector to collect data regarding a use of the electronic device and the pattern identifier to identify a pattern of activity and inactivity of the electronic device based on the data regarding the use of the electronic device. In this example, the scheduler determines (1) a first interval wherein the electronic device is predicted to be inactive and charging of a battery of the electronic device is to be capped at a first level, (2) a second interval wherein the electronic device is predicted to be active and charging of the battery is to be capped at a second level, and (3) a buffer interval between the first interval and the second interval wherein the battery is charged from the first level to the second level. The electronic device also includes a battery controller to regulate battery charging based on a schedule of the first interval, the second interval, and the buffer interval and responsive to a battery level in the first interval being greater than the first level, discharge the battery to the first level.

The present specification also describes a non-transitory machine-readable storage medium where the term “non-transitory” does not encompass transitory propagating signals. The non-transitory machine-readable storage medium is encoded with instructions executable by a processor of an electronic device to, when executed by the processor, cause the processor to determine, based on historic information, a pattern of activity and inactivity of the electronic device and to determine, based on historic information, a battery charge rate. The non-transitory machine-readable storage medium also includes instructions executable by the processor to, when executed by the processor, cause the processor to set, based on the pattern of activity and inactivity of the electronic device and the battery charge rate, a charging schedule for the battery. In an example, when in a first multi-hour interval when the electronic device is predicted to be inactive, the instructions cause the processor to cap a charge of the battery at a first level and when in a second multi-hour interval when the electronic device is predicted to be active, the instructions cause the processor to not cap charging of the battery. When in a buffer interval, the instructions cause the processor to remove the cap and charge the battery beyond the first level. The non-transitory machine-readable storage medium also includes instructions executable by the processor to, when executed by the processor, cause the processor to regulate battery charging based on the schedule.

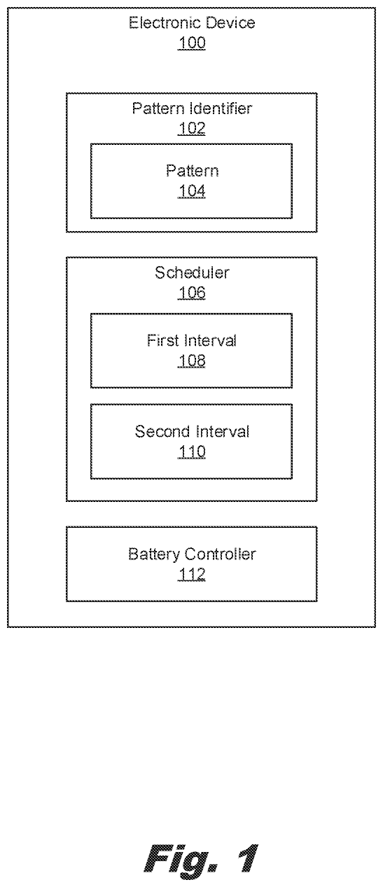

Turning now to the figures, FIG. 1 is a block diagram of an electronic device 100 to regulate battery charging, according to an example. As described above, the electronic device 100 may be of a variety of types including a desktop computer, a laptop computer, an all-in-one-device, a tablet, a smart phone, and a wearable smart device or any other electronic device 100. While particular reference is made to a few types of electronic devices 100, there are innumerable types of electronic devices 100 to which the current specification may apply.

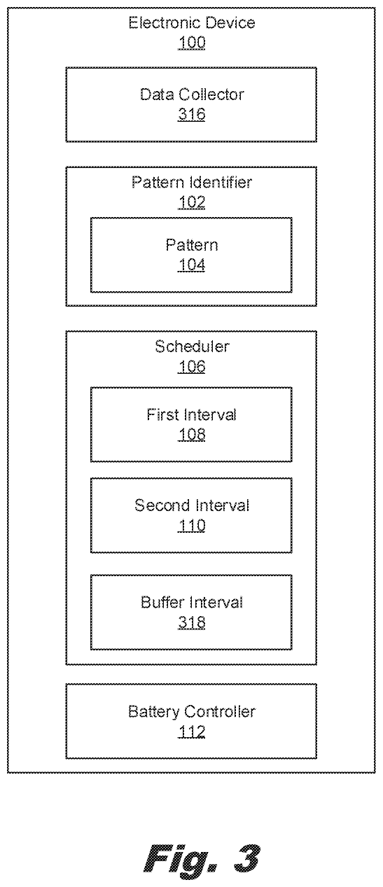

The pattern identifier 102, scheduler 106, and battery controller 112, as well as the data collector depicted in FIG. 3. may include various hardware components, which may include a processor and memory. The processor may include the hardware architecture to retrieve executable code from the memory and execute the executable code. As specific examples, these components may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the corresponding component cause the corresponding component to implement the functionality described herein.

The electronic device 100 includes a pattern identifier 102 to identify a pattern 104 of activity and inactivity of the electronic device 100. That is, over the course of a day or a week, a particular electronic device 100 may have intervals of activity interspersed among intervals of inactivity. For example, during the business hours, a laptop may be actively used to execute any number of operations. By comparison, at night, the laptop may be inactive and components therein shutdown or are placed in a standby mode.

The pattern 104 of activity and inactivity may be more complex. For example, the pattern 104 may indicate that the electronic device 100 is active and being used between the hours of 9:00 am and 12:00 pm followed by an inactive interval from 12:00 pm to 1:00 pm, for example as the user is out to lunch. The pattern 104 may indicate activity again between the hours of 1:00 pm and 5:00 pm after which the electronic device 100 is inactive from 5:00 pm until 9:00 am the next morning. Such a pattern 104 may repeat each day of the week. In one example, different days of the week and in some cases different weeks, may have different intervals of activity and inactivity.

The pattern 104 may be identified in any number of ways. For example, by detecting user input, analyzing display device status information, processor status information, and battery level information, the pattern identifier 102 may identify when an electronic device 100 is active or inactive, and may determine a daily, weekly, or other time-based pattern 104 of activity and inactivity.

Based on this pattern 104, the scheduler 106 of the electronic device 100 may determine different intervals. Specifically, the scheduler 106 may determine a first interval 108 wherein the electronic device 100 is predicted to be inactive. During the first interval 108, charging of the electronic device 100 battery may be capped at a first level. That is, during periods of predicted inactivity, the scheduler 106 may allow the battery to be charged up to, but not past the first level. As will be described below, to do so the battery controller 112 may enforce a charge limit. In some examples, if the battery level is greater than the first level during this first interval, the battery controller 112 may actively discharge the battery level to the first level. Maintaining the battery level to the first level during this first interval when the electronic device 100 is not in use may prolong the life of the battery as maintaining the battery at a full capacity may negatively impact the battery, for example by reducing the amount of charge the battery can hold.

The scheduler 106 may determine a second interval 110, wherein the electronic device 100 is predicted to be active. During this second interval 110, the battery charge level may be capped at a second level, for example 100% of full battery capacity. That is, in this second interval 110, the battery controller 112 may remove any charge limit and allow the battery to fully charge. Doing so may provide the user with the full capacity of the battery during times when a user may so desire, for example during use. Accordingly, the present electronic device 100 reduces the battery level during times when a user is not actively using the electronic device 100 and may not dictate a full battery charge, and provides the full battery capability at times when the user is actively using the electronic device 100 and may desire the full capacity to execute a full complement of electronic device 100 operations.

Accordingly, the electronic device 100 may include a battery controller 112 to regulate battery charging based on the determined schedule of first intervals 108 and second intervals 110. That is, the scheduler 106 may determine when to charge the battery to a first level and when to charge the battery to a second level and the battery controller 112 executes the battery charging accordingly.

The battery controller 112 may include hardware components to determine which source (alternating current (AC) or battery) is actively providing power to the electronic device 100. The battery controller 112 also regulates how much AC power is supplied to charge the battery. As the battery controller 112 is in communication and regulates power delivery to the battery, the battery controller 112 may determine when the battery is at the first level. When the battery controller 112 determines the battery is at the first level, the battery controller 112 may disrupt additional charging. For example, the battery controller 112, once the battery reaches the first level, may disrupt a power path between a power source, such as an AC adapter and the battery. As such, the battery controller 112, may include a number of switches to establish and/or disrupt the power path. As such, the present electronic device 100 extends the battery health and longevity based on specific usage information per user by learning the historic user behavior and avoiding high state of charge on the battery when the user is historically inactive.

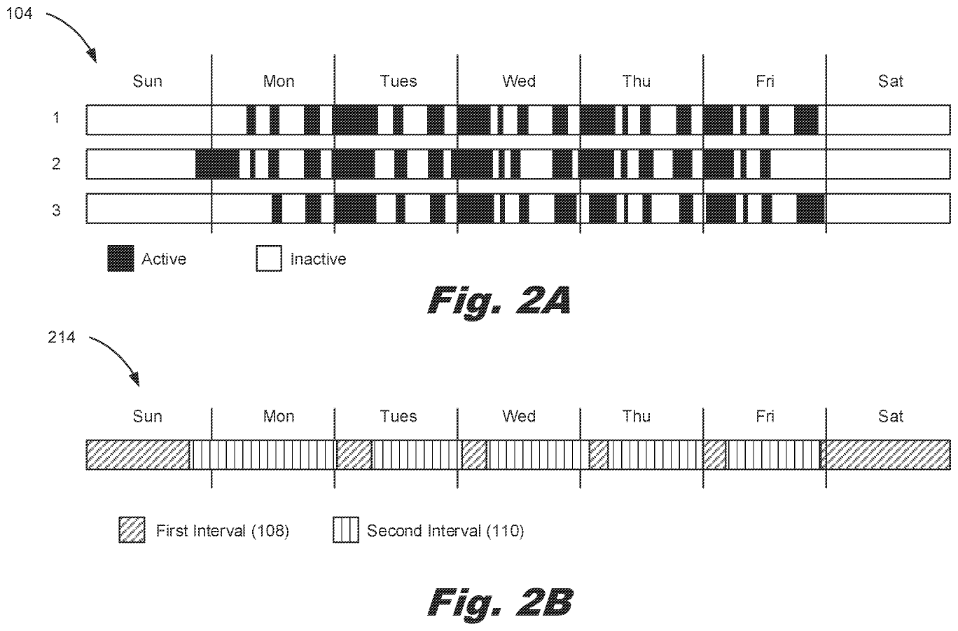

FIGS. 2A and 2B depict a pattern 104 of activity and a schedule 214 for regulating battery charging, according to an example. Specifically, FIG. 2A depicts a pattern 104 identified by the pattern identifier 102 and FIG. 2B depicts the schedule 214 of first intervals 108 and second intervals 110 determined by the scheduler 106. In FIG. 2A, periods of activity are indicated with black boxes and periods of inactivity are indicated with white boxes. As described above, an electronic device 100 may be subject to different levels of use throughout the day and week. For example, on Saturdays and Sundays, the electronic device 100 may not be used as much as compared to during a work week. Accordingly, the pattern identifier 102, in some cases relying on operations of a data collector, may identify such periods of activity and inactivity.

As described above, the inactivity and activity may be detected in a variety of ways. A few examples are now provided. In an example, inactivity and activity may be determined based on keystroke, or other input, information. For example, when using a laptop computer, a user may be typing in a word processing application. Such keystroke information may be indicative of user activity. In another example, when using a touchscreen device, a user may be entering text, and/or browsing the internet. Such touchscreen information may be indicative of user activity.

In another example, the activity may be indicated by display device information, such as for example a display device state. That is, the electronic device 100 may include a monitor/sensor that determines whether or not a display device is in a sleep state or an active state. Again, such information may be indicative of activity of the user.

As yet another example, a rate of battery level change may be indicative of user activity. For example, a battery of the electronic device 100 may drain more slowly if not used as compared to when the electronic device 100 is actively executing applications and operations.

Yet another example is a processor usage rate and/or an application usage. That is, the electronic device 100 may include a monitor/sensor that measures the output or power consumption of the processor of the electronic device 100, which output may be indicative of electronic device 100 activity.

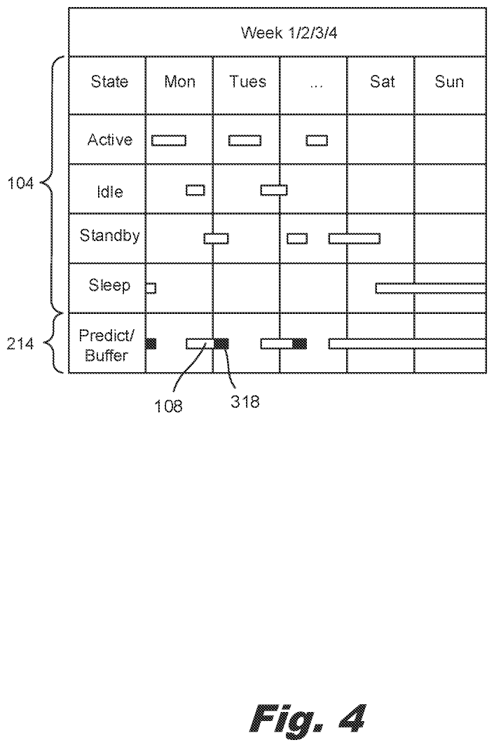

As yet another example, electronic device 100 state may be monitored to identify the periods of activity and inactivity. That is, the electronic device 100 may be in a S0, S1, S3, S4, or S5 state, each indicative of a particular state of the electronic device 100 and the hardware components disposed therein. Such an electronic device state may be monitored and used to determine the pattern 104. Additional detail regarding electronic device 100 state indicating the pattern 104 is provided below in connection with FIG. 4. While specific reference is made to various factors indicating activity and inactivity, the pattern identifier 102 may rely on any number of factors and combination of those factors to determine when the electronic device 100 is active.

As depicted in FIG. 2A, the electronic device 100 may be active and inactive in interspersed intervals throughout the day and throughout the week, with the periods of inactivity and activity potentially being different for different days and weeks. In some cases, rather than capping the battery charge for each period of inactivity, the scheduler 106 may identify as the first interval 108, an interval when the electronic device 100 is predicted to be inactive for greater than a threshold amount of time. That is, if the electronic device 100 is not predicted to be idle for the threshold amount of time, it may be burdensome to switch the battery charge profile. As such, detection of activity may be time-stamped such that a time-based indication of activity may be determined and a pattern identified. Accordingly, as depicted in FIG. 2B, the first intervals 108 may be those periods of time when the electronic device 100 is predicted to be inactive for a threshold amount of time, for example more than 3 hours.

FIG. 3 is a block diagram of an electronic device 100 to regulate battery charging, according to an example. In this example, the electronic device 100 includes the pattern identifier 102, scheduler 106, and battery controller 112 as described above. In this example, the electronic device 100 may include additional components such as a data collector 316 which collects data regarding the use of the electronic device 100. For example, the data collector 316 may be a hardware component such as a monitor or sensor that detects any of the aforementioned indicia of user activity including keystroke input, display device status, processor usage, application usage, electronic device 100 state, and/or battery levels.

Using this data regarding the use of the electronic device 100, the scheduler 106 may determine the aforementioned intervals. Specifically, the first interval 108, which is when the electronic device 100 is predicted to be inactive and charging of the battery of the electronic device 100 is to be capped at a first level and a second interval 110, which is when the electronic device 100 is predicted to be active, and the charging of the battery of the electronic device 100 is to be capped at a second level, nor not capped at all.

In addition to these intervals, the scheduler 106 may determine another interval. Specifically, the scheduler 106 may determine a buffer interval 318, which is an interval between the first interval 108 and the second interval 110 wherein the battery is charged from the first level to the second level. That is, in an example, during the first interval 108 the battery may be maintained at 80% full capacity. Upon entry to the second interval 110 wherein a full battery capacity is desired by the user, the electronic device 100 may not be able to instantaneously provide a fully charged battery. Accordingly, the buffer interval 318 represents an interval between the first interval 108 and the second interval 110 when the battery is charged from the first level, i.e., 80% to the second level, i.e., 100%. The buffer interval 318 may ensure that the user receives a battery that is charged as desired. As such, when the period of inactivity is coming to a close, the electronic device 100 may again enable 100% charging to allow the user to have access to the full battery capability when active, while at same time enhancing battery health by reducing long periods of time spent at 100%.

The buffer interval 318 may be any amount of time and may be determined based on any number of factors. For example, the scheduler 106 may determine the buffer interval 318 based on a confidence in predicted activity and inactivity. For example, if the data collector 316 has detected that the electronic device 100 is turned on each morning at 7:00 am, then the buffer interval 318 may be set to allow charging towards the second level at 1 hour prior to the start of a second interval 110. By comparison, if the data collector 316 is 80% confident that the electronic device 100 will be turned on at 7:00 am, the buffer interval 318 may be 1.5 hours, to account for those circumstances when the electronic device 100 is turned on before 7:00 am.

In another example, the scheduler 106 determines the buffer interval 318 based on historical information regarding a battery charge rate. That is, as described above, the electronic device 100 may include a battery controller 112 that monitors the recharge/discharge of the battery. Such a battery controller 112 may be used to identify how long it takes the battery to charge from the first level to the second level based on different operational scenarios, i.e., different execution set of applications. The buffer interval 318 may be determined based on historic information regarding how long the battery takes to re-charge.

As yet another example, the historic information on which the buffer interval 318 is determined may be from another electronic device. That is, over the life of the battery, the recharge rate may change. For example, an electronic device 100 that is 2-months old may take 20 minutes to charge from 80% capacity to 100% capacity. However, when the electronic device 100 is 3-years old it may take 40 minutes to charge from 80% capacity to 100% capacity. As such, the electronic device 100, relying on historical information extracted from a local memory device or from a remote device, may acquire information regarding historical charge rates of other similar electronic devices 100 having a similar age, and may determine the buffer interval 318 based on such historical information.

In one particular example, the scheduler 106 may update the schedule based on a detected change in a time zone of the electronic device 100. That is, the schedule may be based on an internal clock of the electronic device 100. When a processor of the electronic device 100 or the user, indicates a different time zone, the schedule may be updated to so reflect.

The electronic device 100 may also include the battery controller 112, which as described above, may regulate battery charging based on a schedule of the first interval 108, second interval 110, and the buffer interval 318 by, for example, blocking or allowing a charger to recharge the battery.

In another example in addition to avoiding the battery from charging above the first level in the first interval, the battery controller 112 may, responsive to a battery level in the first interval 108 being greater than the first level, discharge the battery to the first level. For example, given a first level of 80% of full capacity, the battery may enter the first interval 108 with a battery level of 90%. In this example, the battery controller 112 may discharge the battery to reduce the battery level to the first level, in this example 80%. This may be done in any number of ways. For example, the battery controller 112 may disrupt a power path between a power source, such as an AC adapter, and the battery. In another example, the battery itself may be placed into a different state, for example a no-charge state, wherein even if the battery were connected to a power source, it would not accept a charge from the power source.

As yet another example, the battery controller 112 may change or maintain the electronic device 100 in a non-sleep state, i.e., a power consuming state, to induce battery consumption and to discharge the battery. That is, the electronic device 100 may have different states, some of which consume power and others, such as a sleep state, which do not consume power. In order to draw down the battery to the first level, the electronic device 100 may be placed in any of the power consuming states to more quickly draw down the battery while it is decoupled from an external power supply and/or in a no-charge state. The scheduled battery discharge dynamically reduces the battery state of charge to avoid the battery being in a high state of charge, which as described above, may reduce the overall performance of the battery.

FIG. 4 depicts a pattern 104 of activity for regulating battery charging, according to an example. In an example, the pattern 104 may be identified based on an electronic device 100 state. That is, the electronic device 100 has a variety of operational states. FIG. 4 depicts various of those states. For example, the electronic device 100 may be in an active state, which may be an S0-active state. In this state, the electronic device 100 may be actively executing operations and perform functions based on user input.

At different times, the electronic device 100 may be in an idle state, or an S0-idle state. When in the S0-idle state, the hardware components of the electronic device 100 may be active, but a user may not be actively using the electronic device 100. For example, the user may have walked away from the computer. In this example, the data collector 316 may distinguish between the S0-active and S0-idle state for example via input device output. For example, if the data collector 316 identifies that a keyboard, mouse, and/or touchscreen of the electronic device 100 is receiving input and delivering output, then the data collector 316 may identify that the electronic device 100 is in an S0-active state. By comparison, if the hardware components such as a processor and display device are active, but no input is detected, the data collector 316 may determine that the electronic device 100 is in an S0-idle state.

The electronic device 100 may be in a standby mode, which may be referred to as modern standby or S0iX. In this state, the electronic device 100 may be running in a low power state. In such a state, the display panel may be off. The standby mode may be triggered when a user closes a notebook lid or hits a sleep button. In the standby mode, even though the electronic device 100 appears to be off, quick bootup is provided. That is, in this state, the electronic device 100 consumes a reduced amount of power in order to be quickly booted up, but does not consume as much power as when the electronic device 100 is in the active or idle states described above.

The electronic device 100 may be in a sleep state, which may be referred to as S4 or S5. In this state, power consumption is reduced further and the electronic device 100 may save contents of volatile memory to a hibernation file to preserve the state of the electronic device 100. In such a sleep state, some components, such as a keyboard or screen, of the electronic device 100 may remain powered such that the electronic device 100 may boot. The electronic device 100 may enter this sleep state via user input, for example a user switching off the computer. In another example, the electronic device 100 may enter a sleep state after a certain amount of time being in a previous state without activity. For example, after being in a standby mode for 4 hours, the electronic device 100 may enter the sleep state.

In an example, the pattern identifier 102 determine a state-based schedule 214 based on a report that is generated and records information regarding electronic device 100 battery and sleep states. This report may provide a log and timestamps that indicate how long the electronic device 100 was in each state.

FIG. 4 also depicts the schedule 214, i.e., first intervals 108 of predicted periods of inactivity and the buffer intervals 318. As depicted in FIG. 4, the pattern 104 is sorted and averaged into 3 hr.+interval sessions for the week. The scheduler 106 then creates predictions of the timeslots that users may not be using their electronic device 100. In the specific example depicted in FIG. 4, a weekly pattern 104 may arise that highlights active use (S0-active) during the weekday mornings and afternoons, and then a pattern of idleness (S0-idle, S0iX, S3, S4, S5) during middays, evenings, and weekends. Once the weekly pattern 104 is determined, the battery controller 112, relying on the schedule 214, can either cap charging to a first level, or even proactively discharge a battery to the first level. When the period of inactivity (idle) is about to end, the battery controller 112 allows the battery to reach a second level, which may be full battery capacity in anticipation of a user desiring a full capacity soon.

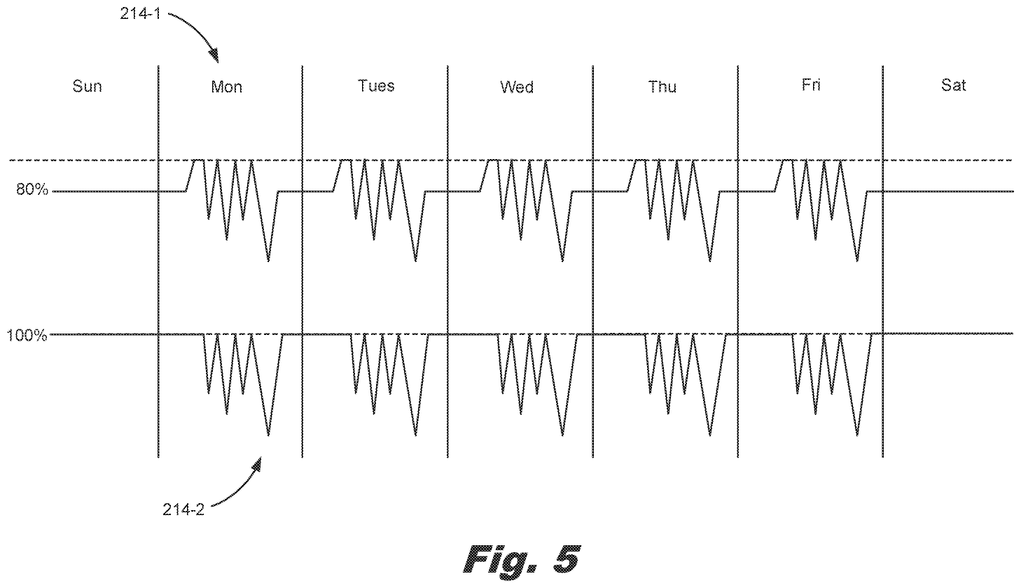

FIG. 5 depicts a schedule 214 during battery charge regulation, according to an example. Specifically, FIG. 5 depicts a first schedule 214-1 that caps battery levels to a first level during periods of predicted inactivity and a second schedule 214-2 that does not cap battery levels during periods of predicted inactivity. As depicted in FIG. 5, the battery level may fluctuate during periods of activity, for example in the middle portion of a day. However, at other times, the battery level may remain more consistent. When implementing an electronic device 100 that regulates battery charge based on activity, the electronic device 100 battery spends less time in a high state of charge, which as described above, preserves the battery life and performance.

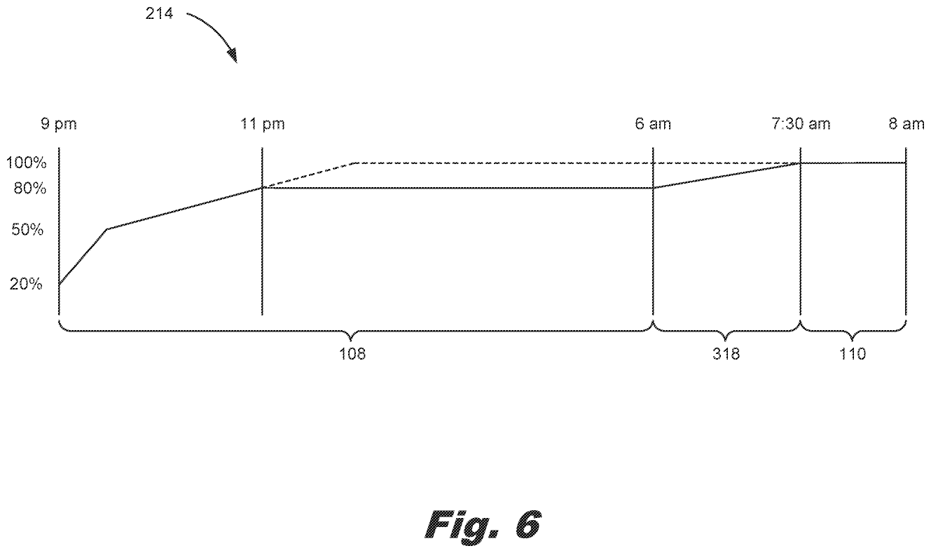

FIG. 6 depicts a schedule 214 during battery charge regulation, according to an example. Specifically, FIG. 6 depicts a first interval 108 when the electronic device 100 is predicted to be inactive, a buffer interval 318 when the battery level is charged to full capacity, and a second interval 110 when the electronic device 100 is predicted to be active. In this example, at 9 pm, the electronic device 100 may be coupled to an external power supply and may have an initial battery level of 20%. As it is in the first interval 108, battery charging may be capped at 80% as depicted by the solid line. In some examples, the battery controller 112 may initiate a fast charge sequence up to some threshold level such as 50% where the battery is charged more quickly. Once the battery reaches this threshold level, the fast charge sequence may be terminated in favor of a standard charge. As depicted in FIG. 6, once the battery reaches the first level, which in this example is 80%, charging may be disrupted. At the end of the first interval 108 and during the buffer interval 318, the cap on the battery charge/level may be removed such that the battery controller 112 resume charging of the battery to the second level, which may be 100%.

FIG. 6 also depicts as a dashed line the battery level were such an intelligent scheduler 106 not implemented. As such, FIG. 6 depicts the reduction in the amount of time the battery is in a high state of charge. As depicted in FIG. 6, due to the relaxing of the cap during the buffer interval 318, the electronic device 100 may have a full battery charge at the beginning of the second interval 110, which begins at 7:30 am. At this time, it may be predicted that the electronic device 100 is to be unplugged from the external power supply.

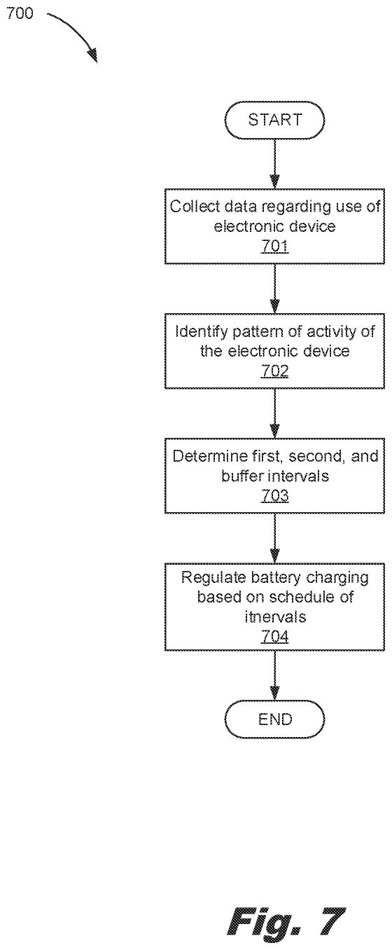

FIG. 7 is a flowchart of a method 700 for regulating battery charge, according to an example. At step 701 the method 700 includes collecting data regarding use of the electronic device 100. That is, as described, the electronic device 100 may include any number of data collectors 316, such as input device monitors, system state monitors, etc. that collect data indicative of activity of the electronic device 100 and/or its components. At step 702, the method 700 includes identifying a pattern 104 of activity and inactivity of the electronic device 100. That is, intervals of activity as identified by the data collector 316 are distinguished from intervals of inactivity. At step 703, the method 700 includes determining the first intervals 108 when the electronic device 100 is predicted to be inactive, the second intervals 110 when the electronic device 100 is predicted to be active, and the buffer intervals 318 when a battery charge/level cap is to be released and the battery level is allowed to raise to the full level. At step 704, the method 700 includes regulating the battery charging based on the schedule of intervals. That is, during the first interval 108, battery charging is capped at a first level due to the predicted inactivity of the electronic device 100. However, it may be the case that even though the electronic device 100 is predicted to be inactive, the electronic device 100 may be activated in this period. Accordingly, response to a detected activity of the electronic device 100 in the first interval 108, the battery controller 112 may remove the cap and allow the battery level to rise above the first level cap.

During the buffer interval 318, the cap may also be removed such that the battery may charge and provide a full capacity during the second interval 110 when the electronic device 100 is predicted to be active.

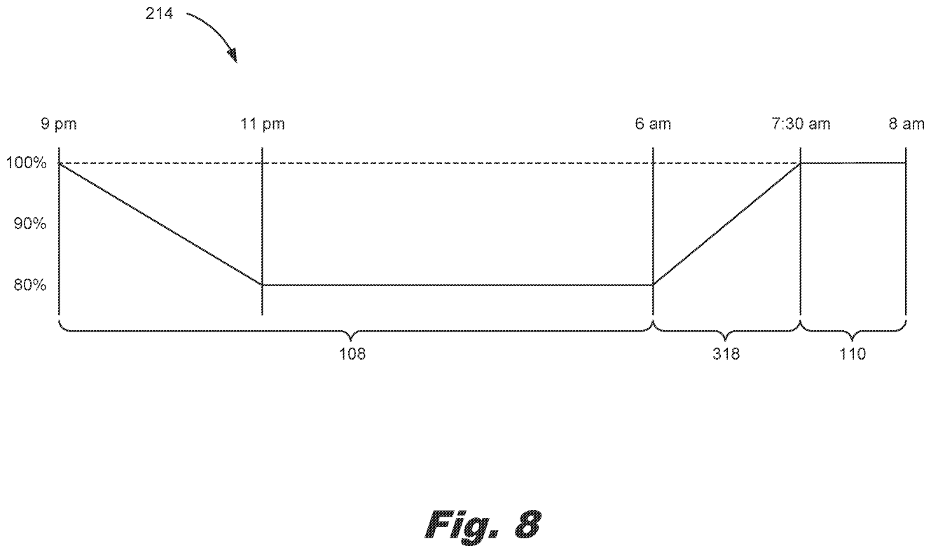

FIG. 8 depicts a schedule 214 during battery charge regulation, according to an example. As described above, in some examples, the battery level may be greater than the first level upon entry into the first interval 108. In this example, the battery controller 112 may actively discharge the battery level by, for example, placing the battery in a no-charge state and interrupting a power path between the power supply and the battery.

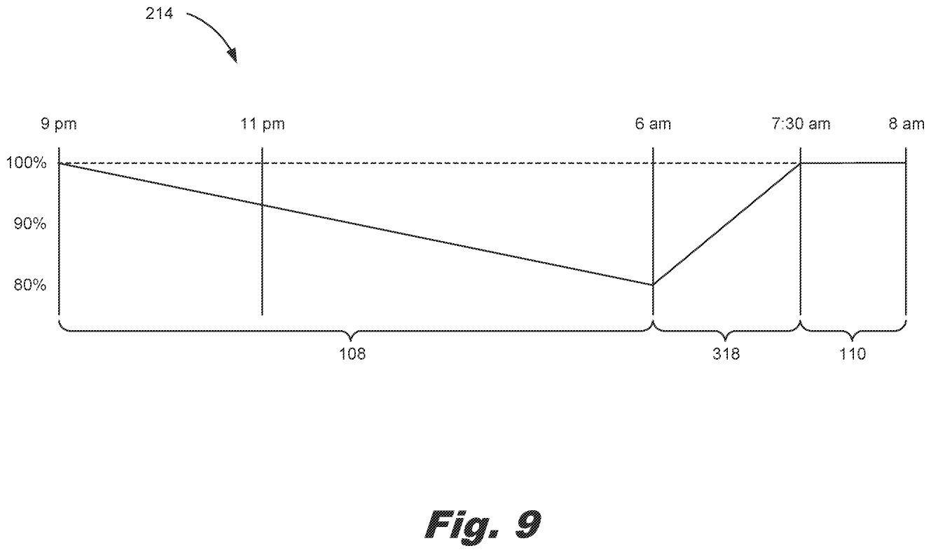

Further to discharge the battery, the electronic device 100 may be maintained or placed in a power consuming state. In the example depicted in FIG. 8, the electronic device 100 is placed in an active, S0, state. In this state, the electronic device 100 may consume power, for example 5 watts of power, such that the battery level discharges at a higher rate than when in other power states. By comparison, in the example depicted in FIG. 9, the electronic device 100 is placed in a sleep state, i.e., Si0x where less power is consumed such that discharge occurs more gradually. That is, as the active state consumes more power, the electronic device 100 discharges the battery more quickly, such that the electronic device 100 arrives at a lower state of charge more quickly.

FIG. 8 also depicts a reduction in the amount of time that a battery is in a high state of charge. That is, the dashed line indicates the battery level were no intelligent scheduler and battery charge cap implemented. Thus, the area between the dashed line and solid line indicates the reduction in the amount of time that the battery is in the high state of charge and highlights the enhanced health profile for the battery which may result in extended longevity of the battery.

FIG. 9 depicts a schedule 214 during battery charge regulation, according to an example. As described above, in the example depicted in FIG. 9, rather than being in an active state, the electronic device 100 is placed in a standby state where the electronic device 100 consumes less power, for example 150 milliwatt of power. This may result in a slower discharge, but may also be desirable for other reasons, such as maintaining a display device active as would occur in the example depicted in FIG. 8.

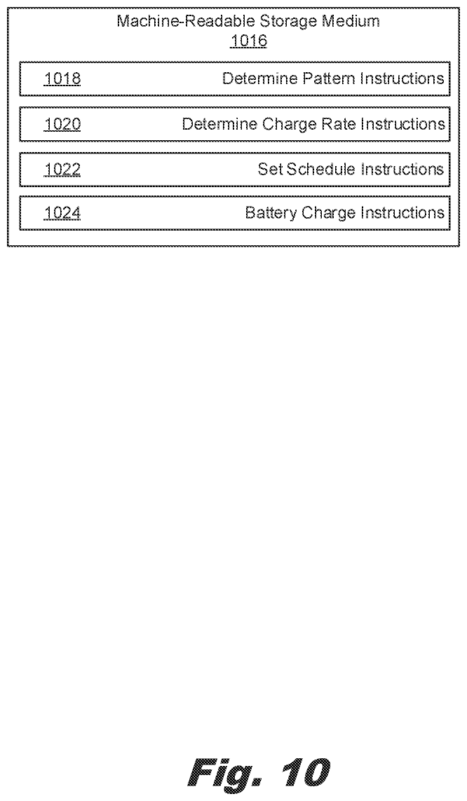

FIG. 10 depicts a non-transitory machine-readable storage medium 1016 for regulating battery charge, according to an example. To achieve its desired functionality, an electronic device 100 includes various hardware components. Specifically, an electronic device 100 includes a processor and a machine-readable storage medium 1016. The machine-readable storage medium 1016 is communicatively coupled to the processor. The machine-readable storage medium 1016 includes a number of instructions 1018, 1020, 1022, 1024 for performing a designated function. The machine-readable storage medium 1016 causes the processor to execute the designated function of the instructions 1018, 1020, 1022, 1024. The machine-readable storage medium 1016 can store data, programs, instructions, or any other machine-readable data that can be utilized to operate the electronic device 100. Machine-readable storage medium 1016 can store computer readable instructions that the processor of the electronic device 100 can process, or execute. The machine-readable storage medium 1016 can be an electronic, magnetic, optical, or other physical storage device that contains or stores executable instructions. Machine-readable storage medium 1016 may be, for example, Random Access Memory (RAM), an Electrically Erasable Programmable Read-Only Memory (EEPROM), a storage device, an optical disc, etc. The machine-readable storage medium 1016 may be a non-transitory machine-readable storage medium 1016, where the term “non-transitory” does not encompass transitory propagating signals.

Referring to FIG. 10, determine pattern instructions 1018, when executed by the processor, cause the processor to, determine, based on historic information, a pattern 104 of activity and inactivity of the electronic device 100. Determine charge rate instructions 1020, when executed by the processor, may cause the processor to, determine, based on historic information, a battery charge rate. Set schedule instructions 1022, when executed by the processor, may cause the processor to, set, based on the pattern 104 of activity and inactivity of the electronic device 100 and the battery charge rate, a charging schedule for the battery. In this example, when in a first multi-hour interval when the electronic device 100 is predicted to be inactive, charging of the battery is capped at a first level. When in a second multi-hour interval when the electronic device 100 is predicted to be active, charging of the battery is not capped. When in a buffer interval 318, the cap is removed and the battery is charged beyond the first level. Battery charge instructions 1024, when executed by the processor, may cause the processor to, regulate battery charging based on the schedule 214.

1. An electronic device, comprising:
a pattern identifier to identify a pattern of activity and inactivity of the electronic device;
a scheduler to determine:
a first interval wherein the electronic device is predicted to be inactive and charging of a battery of the electronic device is to be capped at a first level; and
a second interval wherein the electronic device is predicted to be active and charging of the battery is to be capped at a second level; and
a battery controller to regulate battery charging based on a schedule of the first interval and the second interval.

2. The electronic device of claim 1, wherein:
the first level is 80% of full battery capacity; and
the second level is 100% of full battery capacity.

3. The electronic device of claim 1, wherein the pattern of activity and inactivity is identified based on:
keystroke information;
display device information;
a rate of battery level change;
processor usage;
application usage, or a combination thereof.

4. The electronic device of claim 1, wherein the pattern of activity and inactivity is identified based on an electronic device state.

5. The electronic device of claim 1, wherein, during the first interval, the battery controller is to remove a cap responsive to a detected activity of the electronic device.

6. The electronic device of claim 1, wherein the scheduler is to identify as the second interval, an interval when the electronic device is predicted to be inactive for greater than a threshold amount of time.

7. An electronic device, comprising:
a data collector to collect data regarding a use of the electronic device;
a pattern identifier to identify a pattern of activity and inactivity of the electronic device based on the data regarding the use of the electronic device;
a scheduler to determine:
a first interval wherein the electronic device is predicted to be inactive and charging of a battery of the electronic device is to be capped at a first level;
a second interval wherein the electronic device is predicted to be active and charging of the battery is to be capped at a second level; and
a buffer interval between the first interval and the second interval wherein the battery is charged from the first level to the second level; and
a battery controller to:
regulate battery charging based on a schedule of the first interval, the second interval, and the buffer interval; and
responsive to a battery level in the first interval being greater than the first level, discharge the battery to the first level.

8. The electronic device of claim 7, wherein the scheduler is to determine the buffer interval based on a confidence in predicted activity and inactivity.

9. The electronic device of claim 7, wherein the scheduler is to determine the buffer interval based on historical information regarding a battery charge rate.

10. The electronic device of claim 9, wherein the historical information is from another electronic device.

11. The electronic device of claim 7, wherein the battery controller is to discharge the battery by:
placing the battery in a no-charge state; and
disconnecting a power path between a power source and the battery.

12. The electronic device of claim 11, wherein the battery controller is to discharge the battery further by changing a state of the electronic device to a non-sleep state.

13. A non-transitory machine-readable storage medium encoded with instructions executable by a processor of an electronic device to, when executed by the processor, cause the processor to:
determine, based on historic information, a pattern of activity and inactivity of the electronic device;
determine, based on historic information, a battery charge rate;
set, based on the pattern of activity and inactivity of the electronic device and the battery charge rate, a charging schedule for the battery, wherein:
when in a first multi-hour interval when the electronic device is predicted to be inactive, charging of the battery is capped at a first level;
when in a second multi-hour interval when the electronic device is predicted to be active, charging of the battery is not capped; and
when in a buffer interval, the cap is removed and the battery is charged beyond the first level; and
regulate battery charging based on the schedule.

14. The non-transitory machine-readable storage medium of claim 13, further comprising instructions executable by the processor of the electronic device to update the schedule based on a detected change in a time zone of the electronic device.

15. The non-transitory machine-readable storage medium of claim 13, further comprising instructions executable by the processor of the electronic device to maintain the electronic device in a power consuming state to induce battery consumption and to discharge the battery, responsive to a battery level in the first multi-hour interval being greater than the first level.
